(19) United States
(12) Patent Application Publication
(10) Pub. No.: US 2025/0238063 A1
(43) Pub. Date: Jul. 24, 2025

(54) CONTROL OF ELECTRIC INFRASTRUCTURE INTEGRATED WITH SOLID STATE TRANSFORMERS

(71) Applicant: Nanyang Technological University, Singapore (SG)

(72) Inventors: Gil Lampong OPINA, JR., Singapore (SG); Howe Li YEO, Singapore (SG); Anshuman TRIPATHI, Singapore (SG); Sriram VAISAMBHAYANA BRIHADEESWARA, Singapore (SG)

(21) Appl. No.: 18/421,889

(22) Filed: Jan. 24, 2024

(51) Int. Cl. G06F 1/30; G06F 1/18; G06F 1/26

(52) U.S. Cl. CPC G06F 1/30; G06F 1/189; G06F 1/266

(57) ABSTRACT

A system for controlling an electric infrastructure includes one or more interfaces coupled to one or more stations. The stations are operable to receive first electric energy via a bus. Each station is operable to receive the first electric energy from a power supply and to transmit second electric energy to one or more entities. Each station is operable to transmit third electric energy back towards the bus. A controller system includes the one or more interfaces and a controller. The controller system includes one or more hardware processors that detect an existence of a fault within the electric infrastructure, determine a faulty type, and based on the faulty type, adjust an operation of a particular station of the stations to compensate for the fault. The fault indicates an outage or performance loss.

### TECHNICAL FIELD

This disclosure pertains to controlling an electric infrastructure. For example, the controlling of the electric infrastructure may include operations on the electric infrastructure under different changed conditions, such as faults or imbalances.

### BACKGROUND

Currently, global energy-related carbon (CO₂) emissions amount to over 36.8 billion metric tons per year. Transportation accounts for approximately one-quarter of the global CO₂ emissions. Conversion to electric power trains for vehicles such as land vehicles and maritime vessels is expected to drastically decrease CO₂ emissions. This proliferation of electric vehicles has introduced new challenges with regard to existing electric infrastructures, which currently may not be sufficiently versatile or flexible to effectively react to different changed conditions, such as faults or imbalances.

### SUMMARY

A claimed solution rooted in computer technology overcomes problems specifically arising in the realm of computer technology, in particular, to maintenance and control of an electric infrastructure, network, or grid (hereinafter “infrastructure”), used for power or energy (hereinafter “energy”) distribution. The energy may be supplied by one or more power supplies and distributed to one or more stations via one or more connections or lines, such as transmission lines (hereinafter “transmission lines”). These transmission lines may be connected to a bus, such as a point of common coupling (PCC). The bus integrates or connects the one or more stations with the one or more power supplies. Any or all of the one or more stations may encompass one or more solid state transformers (SSTs) to generate and/or distribute energy of different forms (e.g., direct current (DC) and alternating current (AC)) and at different voltages. The SSTs are equipped to transmit and/or deliver energy to and from the stations bidirectionally. The claimed solution facilitates additional functionalities to seamlessly adapt to different changed conditions, scenarios, and/or situations (hereinafter “changed conditions”).

Each station may include, for example, one or more chargers, batteries, generators, motors, substations, and/or energy sources (hereinafter “energy sources”). Each station may further be integrated with one or more ports, channels, substations, lines, or connections (hereinafter “ports”) that connect, link to, attach, or plug in (hereinafter “connect”) to an entity, device, or load (hereinafter “entity”), which may draw or consume energy from the station.

The electric infrastructure may further include a controller, which may detect changed conditions within the electric infrastructure and control operations of the electric infrastructure to adjust or adapt to those changed conditions. Changed conditions may include, for example, faults (e.g., decreased or compromised performance) within the electric infrastructure. In some examples, faults be manifested as a decrease in transmission quality, which may be evidenced by a decrease in voltage, a decrease in current, increase in interference, or a decrease in energy quality, at the transmission lines and/or at the bus. In other examples, faults may include an outage in at least a portion of the electric infrastructure, and/or a demand, need, deficit, and/or request for energy (e.g., which may exceed available energy at a particular station or port).

The controller may differentiate between faults or fault types, in determining whether to supply reactive power or active power from one or more stations. In a context of the electric infrastructure, reactive power may be used to maintain a stability of the electric infrastructure, by maintaining a voltage within the electric infrastructure (e.g., either at the bus or at the transmission lines) for efficient energy transmission, but is not directly utilized for energy consumption by entities. Therefore, when the controller is coordinating the supply of reactive power from one or more stations, the controller is maintaining a quality of the electric infrastructure, rather than supplying consumable energy to entities. Faults in which the controller determines to supply reactive power, when implementing reactive power compensation, may include a decrease in voltage within the electric infrastructure, but that the electric infrastructure remains connected or at least partially operational. To the contrary, active power may be directly utilized for energy consumption by entities. The controller determines to supply active power during faults such as an outage, in which a voltage is zero or a negligible value.

In some examples, if the controller detects an outage, the controller may control a station to switch from an energy acquiring mode to an energy supplying mode. During the energy supplying mode, the station may, instead of obtaining energy, supply energy to temporarily restore at least a portion of the electric infrastructure. Additionally or alternatively, during a fault, certain requests for energy or scheduled energy at a particular station or port may exceed or deplete an available supply of energy, which results in a potential deficiency. The controller may direct one or more other ports of that station to transmit or distribute energy to the particular port.

Additionally or alternatively, changed conditions may include imbalances and/or irregularities. Imbalances may include an uneven distribution of available electric energy across different stations and/or within different ports of a particular station.

Embodiments of the invention implement a system for controlling an electric infrastructure. The system includes one or more interfaces coupled to one or more stations. Each station includes one or more solid state transformers (SSTs). The one or more stations are operable to receive first electric energy via a bus from a power supply. Each station is operable to transmit second electric energy to one or more entities. Each station is further operable to transmit third electric energy back towards the bus. The system further includes a controller system comprising the one or more interfaces and a controller. The controller system further comprises one or more hardware processors; and memory storing computer instructions, the computer instructions when executed by the one or more hardware processors configured to perform operations. The operations include: detecting or inferring an existence of a fault within the electric infrastructure, the fault indicating an outage or loss in performance in at least a portion of the electric infrastructure. The operations further include, in response to detecting an existence of a fault, determining a fault type. The operations further include, based on the fault type, adjusting an operation of a particular station of the stations to compensate for the fault, the adjusting the operation including coordinating a transmission of the third electric energy towards the bus to compensate for the fault.

In some embodiments, the determining of the fault type comprises detecting that the fault type includes a voltage drop; and the coordinating of the transmission of the third electric energy includes coordinating the particular station to inject a portion of reactive power towards the bus to compensate for the voltage drop.

In some embodiments, the determining of the fault type includes detecting that the fault type includes an outage; and the coordinating of the transmission of the third electric energy includes selecting the particular station to transmit the third electric energy towards the bus based on stored electric energy within the particular station.

In some embodiments, the selecting of the particular station includes determining the particular station has a surplus of stored energy based on an expected energy demand corresponding to the particular station.

In some embodiments, the computer instructions when executed by the one or more hardware processors are further configured to perform: switching a mode of the particular station from an energy acquiring mode to an energy supplying mode, wherein the energy supplying mode transforms or converts the one or more particular stations into one or more grid-forming inverters.

In some embodiments, the computer instructions when executed by the one or more hardware processors are further configured to perform: receiving a request from a particular entity for urgent electric energy from a first station; determining a level of urgency or a level of priority of the request; determining that stored energy at the first station is insufficient to fulfill the request; and selectively redistributing external electric energy from one or more other stations besides the first station to meet the request. The first station may include the particular station or a different station.

In some embodiments, the determining the level of urgency or the level of priority is based on a type of the particular entity.

In some embodiments, the selectively redistributing the external electric energy from the one or more other stations to the first station comprises redistributing the external electric energy in proportion to available energy levels at the respective other stations.

In some embodiments, the computer instructions when executed by the one or more hardware processors are further configured to perform: detecting an imbalance within the electric infrastructure, the imbalance including an uneven distribution of available electric energy across different stations; and in response to detecting the imbalance, selectively redistributing the available electric energy among at least a subset of the different stations.

In some embodiments, a method is implemented by a controller system within an electric infrastructure. The controller system comprises a controller and one or more interfaces coupled to and communicating with one or more stations each comprising one or more solid state transformers (SSTs). The method comprises receiving, at the one or more stations, first electric energy via a bus from a power supply; transmitting, at the one or more stations, second electric energy to one or more entities; detecting an existence of a fault within the electric infrastructure, wherein the fault indicates an outage or a loss in performance in at least a portion of the electric infrastructure; in response to detecting an existence of a fault, determining a type of the fault; and based on the type of the fault, adjusting an operation of a particular station of the one or more stations to compensate for the fault, wherein the adjusting of the operation comprises coordinating a transmission of third electric energy from the particular station towards the bus of the electric infrastructure in order to compensate for the fault.

In some embodiments, the determining of the type of the fault comprises: detecting that the fault type includes a voltage drop; and wherein the coordinating of the transmission of the third electric energy includes coordinating the particular station to inject a portion of reactive power towards the bus to compensate for the voltage drop.

In some embodiments, the determining of the fault type includes detecting that the fault type includes an outage; and wherein the coordinating of the transmission of the third electric energy includes selecting the particular station to transmit the third electric energy towards the bus based on stored electric energy within the particular station.

In some embodiments, the selecting of the particular station includes determining the particular station has a surplus of stored energy based on an expected energy demand corresponding to the particular station.

In some embodiments, the method further comprises switching a mode of the particular station from an energy acquiring mode to an energy supplying mode, wherein the energy supplying mode transforms or converts the one or more particular stations into one or more grid-forming inverters.

In some embodiments, the method further comprises receiving a request from a particular entity for urgent electric energy from a first station; determining a level of urgency or a level of priority of the request; determining that stored energy at the first station is insufficient to fulfill the request; and selectively redistributing external electric energy from one or more other stations besides the first station to meet the request. The first station may include the particular station or a different station.

In some embodiments, the determining the level of urgency or the level of priority is based on a type of the particular entity.

In some embodiments, the selectively redistributing the external electric energy from the one or more other stations to the first station comprises redistributing the external electric energy in proportion to available energy levels at the respective other stations.

In some embodiments, the determining of the fault type includes determining that the fault type includes a harmonic distortion within a waveform of the electric energy; and the coordinating of the transmission of the third electric energy comprises coordinating the particular station to transmit harmonic signals to counteract the harmonic distortion.

In some embodiments, the method includes detecting an imbalance within the electric infrastructure, the imbalance including an uneven distribution of available electric energy across different stations; and in response to detecting the imbalance, selectively redistributing the available electric energy among at least a subset of the different stations.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a diagram of an electric infrastructure that distributes electric energy and responds to faults or imbalances arising within the electric infrastructure, according to some embodiments of the present invention. The electric infrastructure includes one or more SSTs to distribute energy.

FIG. 2 is a diagram illustrating an implementation of a plurality of SSTs within the electrical infrastructure, according to some embodiments of the present invention.

FIG. 3 is a block diagram illustrating details of a controller, which coordinates operations of the stations, to detect and respond to any faults and/or imbalances, according to some embodiments of the present invention.

FIG. 4 is a block diagram illustrating details of a fault detecting engine, according to some embodiments of the present invention.

FIG. 5 is a block diagram illustrating details of a fault addressing engine, according to some embodiments of the present invention.

FIG. 6 is a diagram illustrating an example system for reactive energy compensation upon a decrease in transmission quality being detected within the electric infrastructure, according to some embodiments of the present invention.

FIG. 7 is a block diagram illustrating details of an imbalance detecting engine, according to some embodiments of the present invention.

FIG. 8 is a block diagram illustrating details of an imbalance addressing engine, according to some embodiments of the present invention.

FIG. 9 is a flowchart illustrating a method of detecting and responding to any faults within the electric infrastructure, according to some embodiments of the present invention.

FIG. 10 is a block diagram illustrating details of a computing system.

### DETAILED DESCRIPTION

A claimed solution rooted in computer technology overcomes problems specifically arising in the realm of computer technology, in particular, to maintenance and control of an electric infrastructure. The claimed solution facilitates additional functionalities to seamlessly adapt and react to different changed conditions (e.g., irregularities) within the electric infrastructure, such as a fault (e.g., decreased performance or outage) and/or an imbalance. The electric infrastructure may contain within the one or more stations one or more solid state transformers (SSTs), which supply and distribute energy, and a bus to connect the one or more SSTs with one or more power supplies. The electric infrastructure may contain connections to the stations, which may supply energy to one or more entities. The electric infrastructure may include a controller that controls operations of the electric infrastructure and reacts to certain changed conditions.

Each of the stations, as well as the electric infrastructure, may have bidirectional energy flow attributes. The bidirectional energy flow attributes encompass a capability of acquiring energy into the stations via the connections and transmitting energy out of the stations via the connections. The two different modes may include an energy acquiring mode and an energy supplying mode. During the energy acquiring mode, the controller may control a station to acquire and/or store energy delivered through the one or more SSTs at that station. During the energy supplying mode, the controller may control a station to convert direct current (DC) energy back to alternating current (AC) energy and direct the AC energy back through the connections of the electric infrastructure. The energy supplying mode may occur, for example, in response to a fault such as an outage in the electric infrastructure, which may be due to loss of energy. Thus, by directing energy back into the electric infrastructure, the station may temporarily restore the electric infrastructure affected by an outage.

Another mode relates to diverting or transferring energy among different ports within the stations and/or among the stations. For example, upon detecting a fault, the controller may divert energy to a particular station based on a request to draw energy and/or a level of urgency associated with the request. The level of urgency may depend upon a particular entity and/or an entity type that has requested energy. For example, an emergency response vehicle may be associated with a higher level of urgency (e.g., higher priority) compared to non-emergency vehicles.

Another mode relates to harmonic filtering. The controller may, upon detecting a higher than threshold level of a harmonic current and/or detecting a higher than threshold level of non-linear loads, initiate a harmonic filtering process. Yet another mode relates to power factor correction.

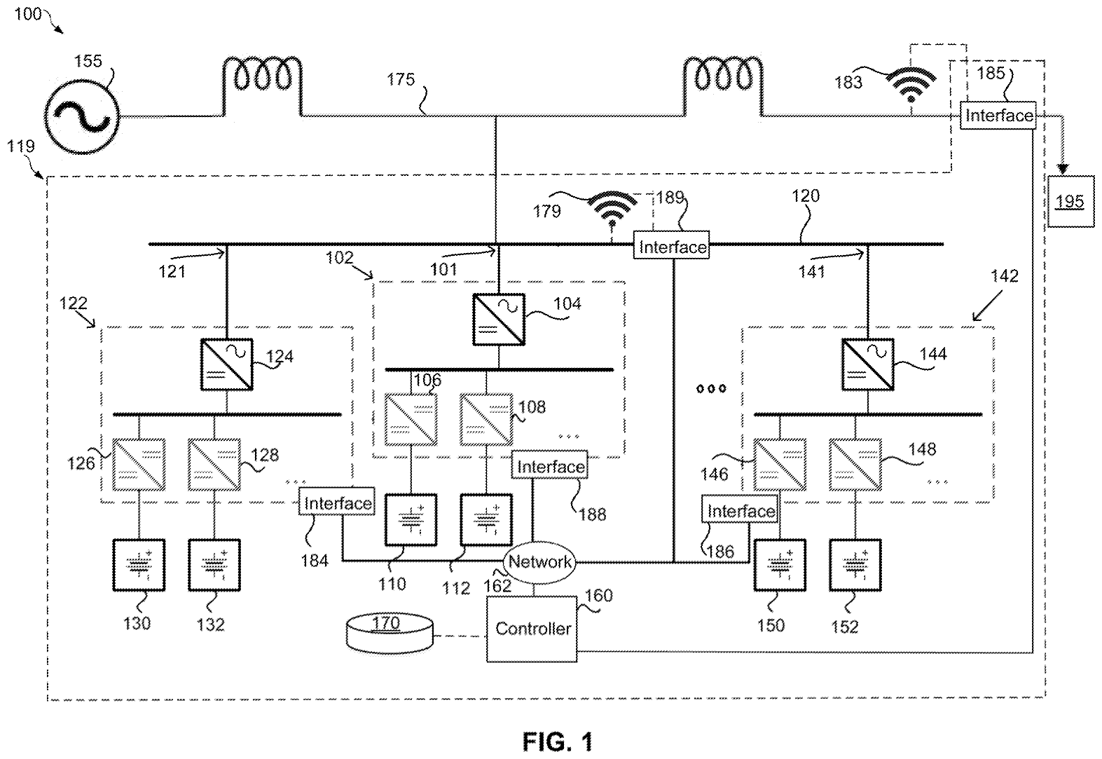

FIG. 1 depicts a diagram of an example electric infrastructure 100. The electric infrastructure 100 may include a power supply 155, transmission lines 175, a bus (e.g., a point of common coupling, or PCC) 120 that links the power supply 155 and the transmission lines 175 to regional infrastructure 119, which includes stations 102, 122 and 142, connections 101, 121 and 141 between the bus 120 and the stations 102, 122 and 142, respectively, and a controller 160 configured to control operations of the stations 102, 122 and 142. The controller 160 may communicate with each of the stations via interfaces 184, 186, and 188, communicate with the bus 120 via an interface 189, and/or communicate with transmission lines 175 via an interface 185. Each of the aforementioned interfaces 184, 186, 188, 189, and/or 185 may be linked to or include one or more sensors to detect changed conditions, such as sensors 179 and 183 associated with the bus 120 and the transmission lines 183. For example, the sensor(s) 179 may detect any of current, voltage, harmonic interference, and/or non-linear loads associated with the bus 120. The sensor(s) 183 may detect any of current, voltage, harmonic interference, and/or non-linear loads associated with the transmission lines 175. The controller 160 may control operations of a region or zone (hereinafter “region”), while each of the stations 102, 122, and/or 142 may control operations within a sub-region. The regions and/or sub-regions, and/or further divisions thereof, may be defined geographically or non-geographically. The transmission lines may also connect to one or more different regional infrastructures 195, which may be implemented in a same or similar manner as the regional infrastructure 119.

In some embodiments, the electric infrastructure 100 may additionally include another level or hierarchy of stations between the regional infrastructure 119 and the transmission lines 175. For example, such a scenario may be applicable if the bus 120 were a low-voltage bus.

Each SST, as implemented, for example, within one or more of the stations 102, 122, and/or 142, may include multiple stages, subcomponents, converters, or portions (hereinafter “stages”), including a first stage that converts AC energy at a first voltage to DC energy at a second voltage, a second stage that converts DC energy at the second voltage to DC energy at a third voltage, and a third stage that converts DC energy at the third voltage to AC energy at a fourth voltage. In some examples, the first voltage may be higher than the second voltage, the second voltage may be higher than the third voltage, and the third voltage may be higher than the fourth voltage. Therefore, successive stages may continuously reduce output voltages. Other patterns are also possible, e.g., successive stages that increase voltage, cause voltages to rise and fall, cause voltages to fall and rise, etc. The bus 120 may include a low-voltage bus or a medium-voltage bus.

One or more input terminals may supply AC energy into the one or more SSTs to be processed in the first stage. In some examples, the first voltage may be in a range between approximately 2 kilovolts (kV) and 7 kV, or within any subrange thereof. Alternatively, the first voltage may be higher or lower. In a specific example, the first voltage may be approximately 6.6 kV. Following processing by the first stage, the outputted DC energy may be processed in the second stage. In some examples, the second voltage may be in a range of approximately 1 kV to 6 kV, or within any subrange thereof. Alternatively, the second voltage may be higher or lower. The second stage may include a high frequency transformer and a bidirectional dual-active bridge, which facilitates bidirectional flow of energy to and from the one or more SSTs. At an output of the second stage, a terminal may correspond to a DC bus that outputs energy at the third voltage, which may be in a range between approximately 100 and 600 Volts. Alternatively, the third voltage may be higher or lower.

Although three stations 102, 122 and 142 are shown, the electric infrastructure 100 may include any number of stations. In some examples, the stations 102, 122 and 142 may include charging stations. The station 122 may include an energy source 124 such as a charger and/or a generator. Although only a single energy source is shown for the sake of illustration, each station may include any number of energy sources. In some examples, the energy source 124 may include an inverter that converts DC energy to AC energy, which may be applicable when the station 122 distributes electric energy back through the connection 121 towards the bus 120 and/or the one or more SSTs 102. The station 122 may also include one or more ports, which are shown as ports 126 and 128. The ports 126 and 128 may include links to entities 130 and 132, respectively. The entities 130 and 132 may request, draw, and/or consume electric energy from the energy source 124 via the ports 126 and 128. In some examples, the entities 130 and 132 may include any loads that demand, consume and/or store electric energy, such as vehicles. The station 142 may be implemented in an equivalent or similar manner as the station 122, and may include equivalent or similar components including an energy source 144 and ports 146 and 148 through which entities 150 and 152 may link. The station 102 may be implemented in an equivalent or similar manner as the station 122, and may include equivalent or similar components including an energy source 104 and ports 106 and 108 through which entities 110 and 112 may link.

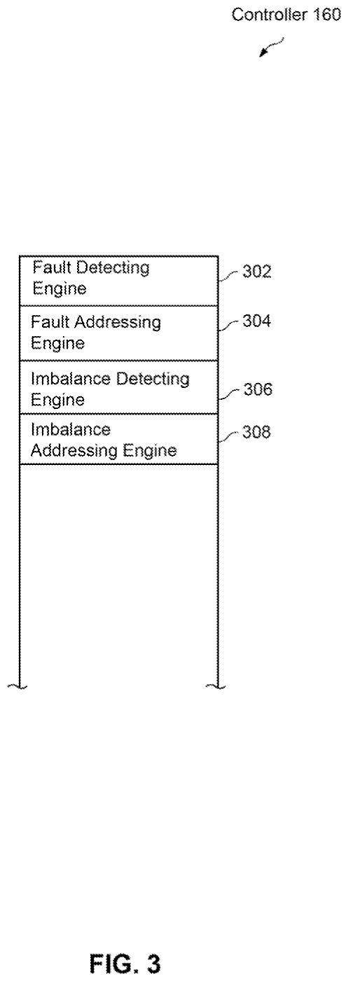

The controller 160 may include software, hardware, and/or firmware to control operations of the one or more stations 102, 122 and/or 142. These operations may include detecting of changed conditions (e.g., faults, imbalances, and/or other irregularities) within the electric infrastructure 100, in particular, within the regional infrastructure 119, and implementing a response to the detected changed conditions. The response may include adjusting an operation or a mode of the one or more stations 102, 122 and/or 142. The controller 160 may include one or more processors and instructions (e.g., which may include parameters, expressions, protocols, evaluations, logical conditions, arguments, and/or functions) to implement the control of the operations, as will be described in FIGS. 3-9. As a result of detecting and responding to changed conditions, the controller 160 effects a seamless transition between different operating modes of the stations 102, 122 and/or 142 to mitigate or prevent any failures and/or other issues within the electric infrastructure 100 while improving quality of power transmission. The controller 160 may utilize a secure and efficient communication protocol to communicate with all stations (e.g., the stations 102, 122 and 142). The controller 160, in some examples, may be adapted to be utilized in conjunction with different types of stations and/or SSTs.

The controller 160 may connect to, receive communications from, and/or transmit communications to any of the stations 102, 122 and 142 and/or any of the entities 110, 112, 130, 132, 150, and 152 via a network 162. The network 162 may include any secured communication network such as an encrypted network. The network 162 may represent one or more computer networks (e.g., LAN, WAN, or the like) or other transmission mediums. The network 162 may provide communication within the regional infrastructure 119 and/or between the regional infrastructure 119 and other different regional infrastructures 195. In some embodiments, the network 162 includes one or more computing devices, routers, cables, buses, and/or other network topologies (e.g., mesh, and the like). In some embodiments, the network 162 may be wired and/or wireless. In some embodiments, the network 162 may be another bus. In various embodiments, the network 162 may include the Internet, one or more wide area networks (WANs) or local area networks (LANs), one or more networks that may be public, private, IP-based, non-IP based, and so forth.

The controller 160 may transmit and receive communications (e.g., requests and/or commands) (hereinafter “communications”) from the one or more stations 102, 122 and 142, are/or any other locations within the electric infrastructure 100 via the one or more interfaces 188, 184, and 186 which are connected via the network 162. In some examples, the interfaces 188, 184, and 186 may constitute circuit interfaces and/or client interfaces. In FIG. 1, for the sake of illustration, the interface 188 may receive and transmit communications between the controller 160 and the station 102. The interface 184 may receive and transmit communications between the controller 160 and the station 122. The interface 186 may receive and transmit communications between the controller 160 and the station 142. The controller 160 may, additionally or alternatively, communicate with the interface 189 that may be connected to the bus 120, and/or the interface 185 that may be connected to the transmission lines 175, and which may transmit and receive communications from the controller 160 to any locations within the electric infrastructure 100. Other configurations that include different numbers and/or arrangements of interfaces are also contemplated.

In some examples, the interfaces 188, 184, and 186 may include software, hardware, and/or firmware to connect to and control operations of the one or more stations 102, 122 and/or 142, and/or any other portions of the electric infrastructure 100. The interfaces 188, 184, and 186 may decipher, convert, and/or translate (hereinafter “translate”) any communications from the controller 160 into actions, such as changes in circuitry (e.g., switching open or closing access to a particular station and/or to a particular port) and/or programming, in order to implement the commands. The interfaces 188, 184, and 186 may also obtain data, such as operational parameters and attributes (e.g., electrical parameters such as voltages or indicators of signal or transmission quality), and/or any results of an action (e.g., whether an action successfully addressed a fault, imbalance, and/or other irregularity) within the station 102, 122, and the station 142, respectively. The interfaces 188, 184, and 186 may transmit any data obtained to the controller 160. The controller 160 may, in turn, store the data within one or more datastores 170.

In some examples, the interfaces 188, 184, and 186 may include or be associated with graphical user interfaces and/or web-based interfaces to enable access to any data obtained and/or communications and/or to permit configuration or management of the controller 160 and/or other aspects of the electric infrastructure 100. The interfaces 188, 184, and 186 may support load balancing during any concurrent requests for access.

In some examples, the controller 160 may implement any or all of the functionalities described with respect to the interfaces 188, 184, 186, 189, and 185. In some examples, the controller 160, combined with the interfaces 188, 184, 186, 189, and 185, and/or the network 162, may form a controller system, to control the operations of the electric infrastructure 100. In some examples, the controller 160 may communicate in an ad-hoc manner with one or more other controllers corresponding to different regional infrastructures (e.g., the different regional infrastructures 195), and/or with a central controller (not shown) that controls operations of all the regional controllers within the infrastructure 100. Therefore, in some examples, a hierarchy of controllers may be implemented, with a central controller that coordinates regional controllers. Although not illustrated in FIG. 1, the controller system 190 may further include any relevant engines, that facilitate communication between the controller 160 and the interfaces 188, 184, and 186, such as communicating engines 401, 501, 701, and/or 801.

The controller 160 may detect and respond to one or more faults within the regional infrastructure 119. For example, the controller 160 may receive a signal or indication (hereinafter “indication”) from the station 102, via the interface 188, of a fault. The fault may be, for example, recognition that an overall amount of energy within the station 102 and/or within one of the entities 110 or 112 is inadequate (e.g., below a threshold level). The controller 160 may receive an indication that none of the other entities within the station 102, either by themselves or cumulatively, have surplus energy to address the inadequacy. The controller 160 may transmit a message to one or more of the other stations 122 and/or 142 within the regional infrastructure 119, via the interfaces 184 and/or 186, to request energy. The controller 160 may receive a signal, for example, from the station 122 via the interface 184, that the station 122 has a surplus amount of energy. The controller 160 may then direct the station 122 to deliver some or all of the surplus energy, via the interface 184, to the station 102, via the bus 120. For example, the controller 160 may direct the station 122 to control one or more switches to permit energy to be transmitted from the station 122 to the bus 120. The controller 160 may then direct the station 102 to control one or more switches to permit energy to be delivered into the station 102. Meanwhile, the controller 160 may then direct the station 142 to control one or more switches to prevent any energy from being diverted unintentionally to the station 142. In such a manner, the controller 160 may control the transmission and receiving of energy at each individual station in a granular manner.

In some scenarios, instead, if the controller 160 determines that none of the stations 102, 122, and 142 within the regional infrastructure 119 have adequate energy to address the deficiency in the station 102, the controller 160 may transmit a message to the interface 185 and/or to a central controller of the infrastructure 100, to request energy from a different region. Upon receiving an indication or determining that a different region has surplus energy to address the deficiency, the controller 160 may control, or coordinate, one or more switches associated with the transmission lines 175, via the interface 185, to receive the energy from the different region. Similarly, the controller 160 may also respond to a message from a different controller in a different region, such as within the different regional infrastructures 195, to address a deficiency within the different regional infrastructures 195.

Furthermore, the controller 160 may react to changed conditions within the bus 120 and/or within the transmission lines 175. For example, the controller 160, upon detecting a decrease in a voltage at the bus 120 and/or at the transmission lines 175, may coordinate reactive power injection from any of the stations 102, 122, and/or 142, via the interfaces 188, 184, and/or 186, respectively. As another example, the controller 160, upon detecting a decrease in a current at the 120 and/or at the transmission lines 175, may coordinate the transformation or conversion of one or more of the stations 102, 122, and/or 142 into one or more grid-forming inverters. As another example, the controller 160, upon detecting that a level of waveform distortion such as harmonic distortion and/or non-linear loads associated with the bus and/or the transmission lines 175, exceeds a threshold level, may initiate a mechanism (e.g., harmonic filtering) to address the waveform distortion. In such a manner, the controller 160 may also address faults in different regions.

The controller 160 may include one or more different processors. For example, the controller 160 may obtain the battery voltages, state-of-charges and charging powers and consolidates the available battery power and battery energy into representations such as matrices. The controller 160 may additionally monitor the voltage of the bus 120 and determine whether the stations 102, 122, and/or 142 should remain connected to the infrastructure 100 during low voltage ride through (LVRT). The controller 160 may consolidate power being consumed by individual stations into representations such as matrices. The controller 160 may perform spectrum analysis, such as a fast Fourier transform (FFT) on a current within any of the stations 102, 122, and/or 142, and/or within the bus 120, and determine harmonic amplitudes and phases of the current. The controller 160 may control any of the stations 102, 122, and/or 142 as a STATCOM when counteracting sags (e.g., voltage sags) within the bus 120. The controller 160 may coordinate transitions or modes of harmonic filtration, power factor correction, STATCOM, and/or grid formation, of any of the stations 102, 122, and/or 142.

The controller 160 may address waveform deficiencies such as harmonics by arranging harmonic components in an order of descending amplitude, selecting a harmonic component to address based on the amplitude (e.g., selecting a largest harmonic component), and selecting an entity with a highest available amount of energy to serve as an active filter. In some examples, if a harmonic component cannot be reduced to an acceptable threshold level, that harmonic component may be disregarded and a largest harmonic component that is reducible to an acceptable threshold level may be addressed. In some examples, before addressing one or more harmonic components, the controller 160 may compute or predict a resulting apparent power following the addressing of one or more harmonic components. If the resulting apparent power is within an acceptable range, then the controller 160 may perform harmonic filtering and/or compensation. If the resulting apparent power is outside of the acceptable range, then the controller 160 may remove a smallest remaining harmonic component out of the one or more harmonic components and once again evaluate whether the resulting apparent power, after removal of the smallest remaining harmonic component, is within an acceptable range.

The controller 160 may further be associated with one or more datastores 170 which may store data accessible by the controller 160 and may be a destination to which data is written. The data within the datastores 170 may include, as nonlimiting examples, historical data, records or logs (hereinafter “records”) of any faults, imbalances, and/or other irregularities within the electric infrastructure 100, records of any operations performed within any of the stations 102, 122 and/or 142, results of any operations performed (e.g., whether an operation successfully resolved a fault, imbalance, or other irregularity), and/or records of energy withdrawals at any of the ports 106, 108, 126, 128, 146, and/or 148. The datastores 170, in some embodiments, may represent one or more logical stores. In some embodiments, the datastores 114 may include relational database management systems (RDBMS), object-based database systems, and/or the like.

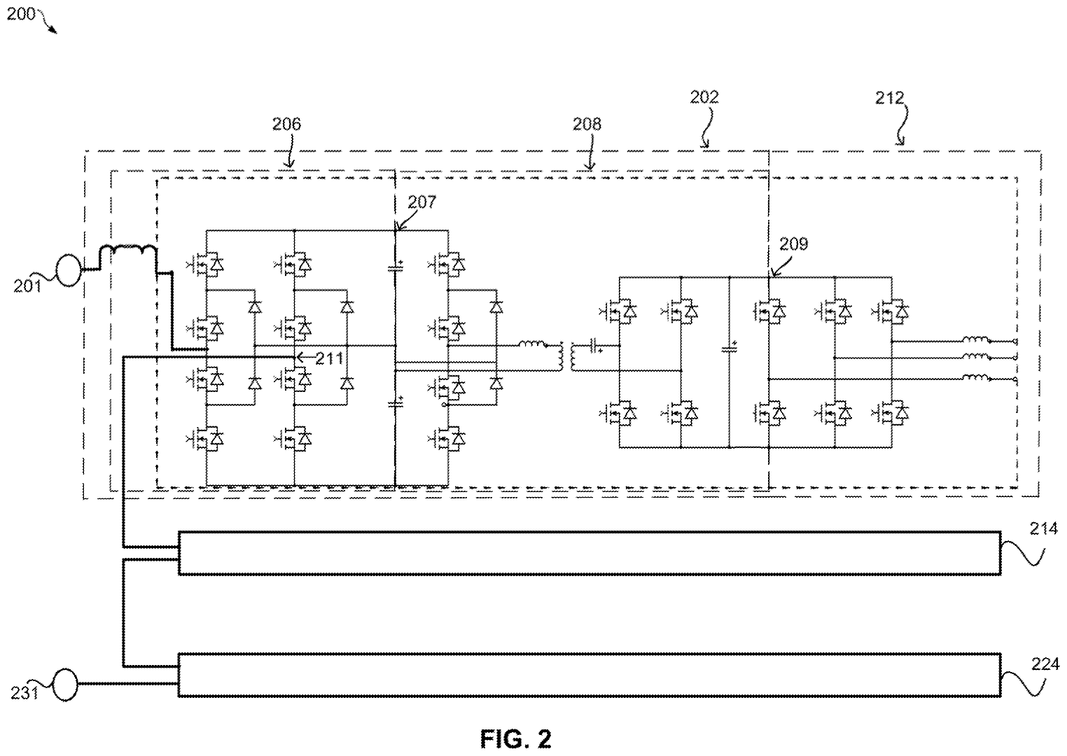

FIG. 2 illustrates an example implementation of the one or more SSTs, which may be implemented within any of the stations 102, 122, and/or 142, to illustrate a combination of multiple SSTs 200 to increase a voltage to be distributed. Any principles described in FIG. 1 may also be applicable to FIG. 2, and vice versa. The combination 200 may include a first segment 202, a second segment 214, and a third segment 224, each of which may have equivalent or analogous components and functionalities. The first segment 202 may include a first stage 206 which converts input AC energy to DC energy, and a second stage 208 which reduces a voltage of the DC energy, for example, using a dual-active bridge. In the first segment, a terminal 207 may correspond to a DC bus, and a terminal 209 may correspond to a DC bus at a lower voltage. The first segment 202 may be linked to the second segment 214 via a terminal 211. By including three segments, a resulting voltage of the combination 200 may be increased. For example, if the first segment 202 corresponds to a voltage of approximately 2.5 kV, the combination 200 may have a voltage of nearly three times that of an individual segment, or approximately 6.6 kV, as measured between a terminal 201 of the first segment 202 and terminal 231 of the third segment 224. In some embodiments, a third stage 212 may include an auxiliary circuit. In some embodiments, the combination of multiple SSTs 200 may exclude the third stage 212.

FIG. 3 is a block diagram illustrating details of the controller 160, which coordinates operations of the stations 102, 122 and/or 142, to detect and respond to any faults, imbalances, and/or other irregularities within the electric infrastructure 100. The controller 160 includes hardware, software and/or firmware capable of secure and efficient communication with the station 102, the stations 122 and/or 142, and/or any of the entities 110, 112, 130, 132, 150, and/or 152, for example, through any of the interfaces previously described (e.g., the interfaces 188, 184, and 186). The controller 160 may include a fault detecting engine 302, a fault addressing engine 304, an imbalance detecting engine 306, and/or an imbalance addressing engine 308. Any engines referred to may comprise software, hardware, firmware, and/or circuitry to perform and/or coordinate operations. Although engines are described separately to illustrate different concepts, it is contemplated that the engines described separately do not necessarily constitute different or separate physical processors. Rather, any of the engines may be integrated or combined into a single processor.

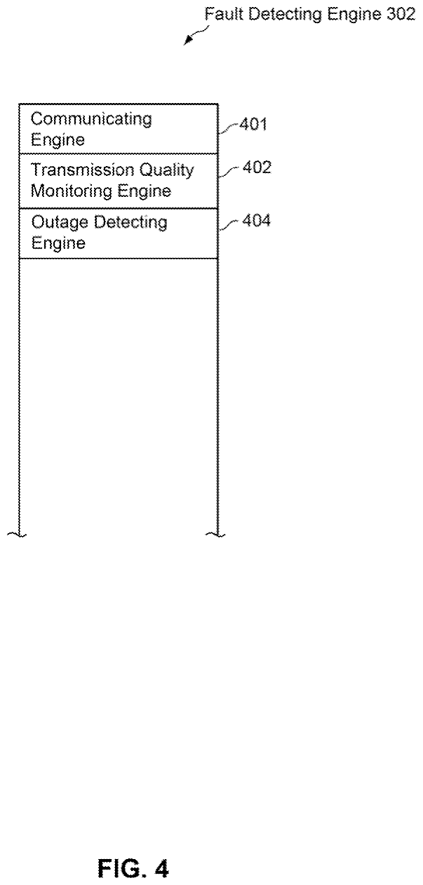

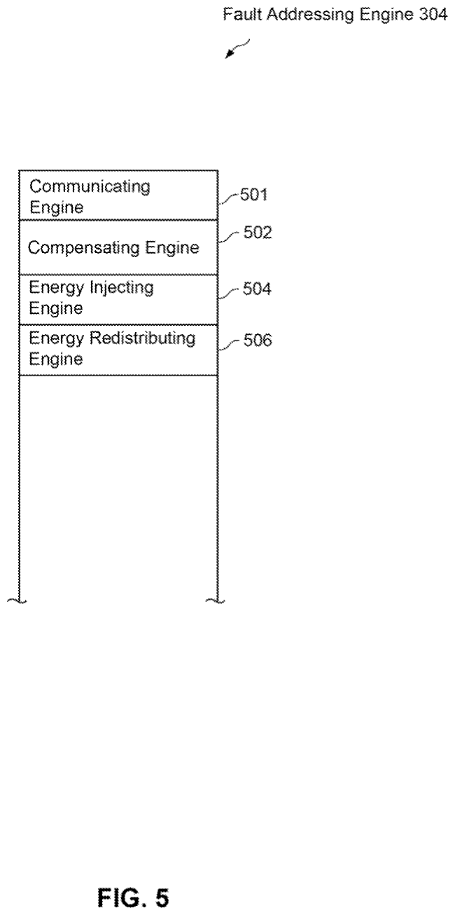

The controller 160, specifically, the fault detecting engine 302, may detect an existence of a fault, such as a loss, reduction or degradation (hereinafter “loss”) in performance, or an outage in any portion of the electric infrastructure 100. A loss in performance may include a reduction in transmission quality, which may be evidenced, for example, by a voltage decrease and/or waveform defects such as harmonic distortion. The controller 160, specifically, the fault addressing engine 304, may, upon detecting such a fault, implement a response by adjusting an operation and/or a mode of any of the stations (e.g., the stations 102, 122 and/or 142). As will be described in FIGS. 4 and 5, the controller 160 may differentiate between faults or fault types in which reactive power is to be supplied from any of the stations and faults or fault types in which active power is to be supplied. Reactive power is to be supplied to maintain a stability and/or quality (hereinafter “quality”) of the electric infrastructure in response to a deteriorating quality. A deteriorating quality may be indicated, for example, by a decrease in voltage in the electric infrastructure, when the electric infrastructure remains at least partially operational. Meanwhile, active power is to be supplied in order to deliver consumable energy to entities, in response to an outage in the electric infrastructure.

In some embodiments, the controller 160, specifically, the fault detecting engine 302, may detect harmonic distortion within a waveform. Upon detecting the harmonic distortion, the fault addressing engine 304 may initiate or control a harmonic filtering process to mitigate or eliminate the harmonic distortion. The fault addressing engine 304 may control one or more of the stations 102, 122 and 142 to perform the harmonic filtering. In some examples, the harmonic filtering may include actively injecting electric signals, such as harmonic signals, to counteract the distortion.

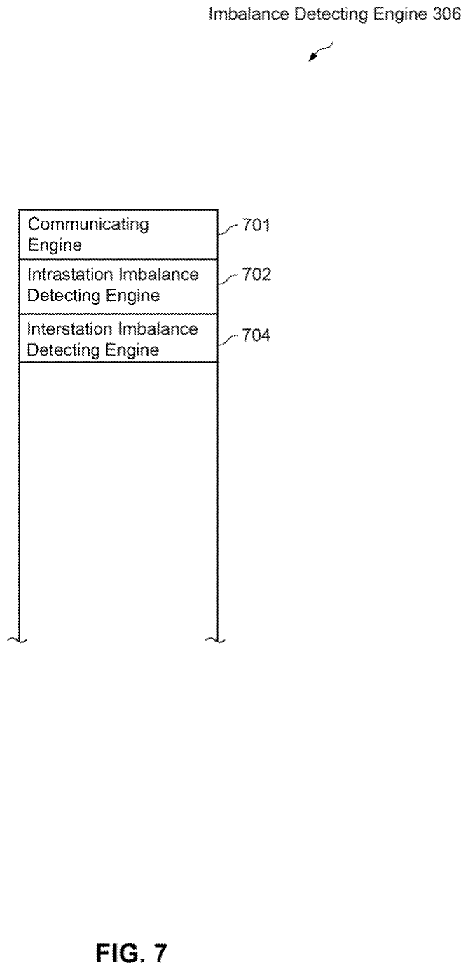

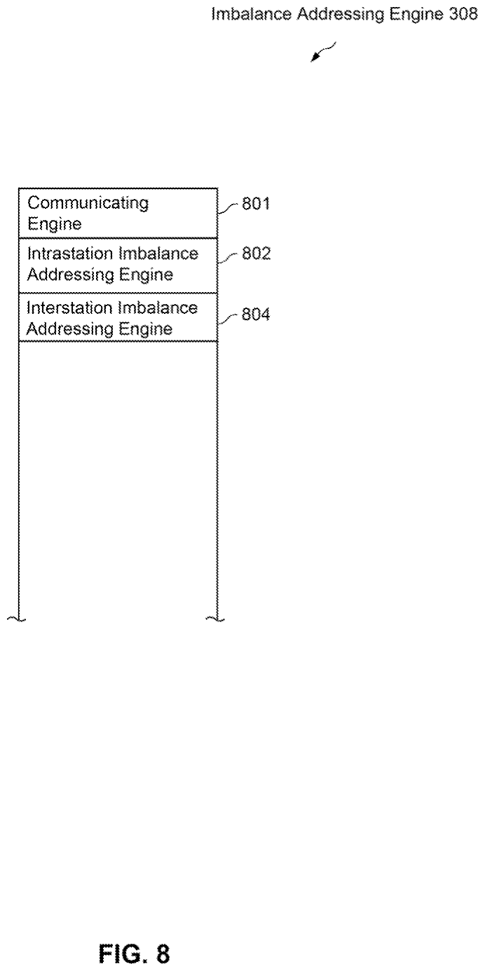

The imbalance detecting engine 306 may detect an imbalance, such as pertaining to a parameter or attribute (hereinafter “parameter”) within the electric infrastructure 100. Such parameters may be obtained, for example, from a relevant interface (e.g., any of the interfaces 188, 184, and 186) and/or from the datastores 170. For example, imbalances in parameters may refer to amounts of stored energy across different stations and/or amounts of stored energy across different energy sources within a particular station that deviate from certain benchmarks. These benchmarks may be based on factors such as historical energy demands at different stations and/or predicted energy demands at the different stations. For example, if the station 122 historically has a higher demand for energy compared to the station 142, an amount of available energy at the station 122 should be higher than that at the station 142. In some examples, if an amount of available energy at the station 122 is less than a predicted future demand for energy, then the station 122 may be predicted to have a deficiency in energy. The imbalance addressing engine 308 may selectively resolve the imbalances, for example, by reallocating, diverting, or redistributing energy from other stations and/or other external sources to the station 122. Details of the imbalance detecting engine 306 and the imbalance addressing engine 308 will be further described in FIGS. 7 and 8.

FIG. 4 is a block diagram illustrating details of the fault detecting engine 302. The fault detecting engine 302 includes hardware, software and/or firmware capable of secure and efficient communication with the stations 102 122 and/or 142, and/or any of the entities 110, 112, 130, 132, 150, and/or 152. The fault detecting engine 302 includes a communicating engine 401, a transmission quality monitoring engine 402, and an outage detecting engine 404 configured to detect different faults or fault types. The fault detecting engine 302 may distinguish between a fault or fault type in which reactive power is to be injected (e.g., upon detecting a transmission quality decrease, when the electric infrastructure remains at least partially operational), compared to a fault or fault type in which active power is to be injected (e.g., upon detecting an outage). The communicating engine 401 includes hardware, software and/or firmware capable of secure and efficient communication with different sites or locations (hereinafter “locations”) of the electric infrastructure 100. These different locations may correspond to the stations 102, 122 and/or 142, and/or any of the entities 110, 112, 130, 132, 150, and/or 152. The communicating engine 401 may receive and/or transmit communications via any of the interfaces 188, 184, and 186. In particular, the communicating engine 401 may receive readings and/or communications from one or more sensors or components. These sensors may measure parameters of the energy being transmitted, such as voltage (e.g., root mean square (RMS) voltage), current, amount of energy delivered, and/or indicators of energy quality such as harmonic distortions. The communicating engine 401 may receive other records or logs of events occurring within the electric infrastructure 100, such as reductions in transmission quality and/or outages. In some embodiments, the communicating engine 401 may transmit a request for information to any of the interfaces 188, 184, and 186. In some embodiments, additionally or alternatively, the communicating engine 401 may automatically receive communications of events and/or data from the interfaces 188, 184, and 186 in real-time, near real-time, or at certain intervals. The communicating engine 401 may transmit any communications received to the transmission quality monitoring engine 402.

The transmission quality monitoring engine 402 may be configured to receive communications from the communicating engine 401, and to detect, determine, or infer a decrease in transmission quality, which may be evidenced, for example, by a change in waveform of a transmitted signal, a voltage decrease (e.g., a voltage sag or an undervoltage condition), and/or a harmonic distortion. In an event of a voltage decrease, a root mean square (RMS) voltage value of a voltage across at least a portion of the electric infrastructure 100 may be reduced. In some examples, the transmission quality monitoring engine 402 may positively determine a transmission quality reduction upon detecting that a voltage has decreased to below a low voltage ride through (LVRT) value, or by at least ten percent compared to a previous average RMS voltage, for a duration of one-half cycle to 500 milliseconds (ms).

Meanwhile, the outage detecting engine 404 may be configured to receive communications from the communicating engine 401, and to detect, determine, or infer an outage within any portion of the electric infrastructure 100. An outage may include an intentional or planned outage, or an unplanned outage. The outage detecting engine 404 may positively determine an outage upon detecting that a measured voltage is at zero, or a negligible value within a range, for at least a threshold period of time.

FIG. 5 is a block diagram illustrating details of the fault addressing engine 304, which includes hardware, software and/or firmware capable of secure and efficient communication with the stations 102, 122 and/or 142, and/or any of the entities 110, 112, 130, 132, 150, and/or 152. The fault addressing engine 304 includes a communicating engine 501, a compensating engine 502, an energy injecting engine 504, and an energy redistributing engine 506, which implement different responses depending on a fault type detected by the fault detecting engine 302. The communicating engine 501 may be configured to communicate with different sites or locations (hereinafter “locations”) of the electric infrastructure 100, for example, when issuing commands to perform certain operations in order to address faults, in conjunction with any of the compensating engine 502, the energy injecting engine 504, and the energy redistributing engine 506. These different locations may correspond to the one or more stations 102, 122 and/or 142, and/or any of the entities 110, 112, 130, 132, 150, and/or 152. The communicating engine 501 may receive and/or transmit communications via any of the interfaces 188, 184, and 186.

The compensating engine 502, in conjunction with the communicating engine 501, may be configured to address a transmission quality reduction, as identified by the transmission quality monitoring engine 402. In an event of a transmission quality reduction, which may be evidenced by a voltage decrease, first, the compensating engine 502 may determine to terminate charging at any of the stations (e.g., the stations 102, 122 and 142) affected or potentially affected by the transmission quality reduction, and initiate such a process. In particular, the communicating engine 501 may transmit an indication or a communication (hereinafter “communication”) to any of the interfaces 188, 184 and 186 to terminate charging at any of the corresponding stations 102, 122 and 142. For example, the communication may include a command to adjust or open a switch or modify circuitry that would result in preventing energy flow into one of the stations 102, 122 or 142.

Second, the compensating engine 502 may determine to switch a mode of any of the stations 102, 122 and 142 to inject reactive power towards the bus 120. The communicating engine 501 may transmit a communication to any of the interfaces 188, 184 and 186 to switch a mode of any of the stations 102, 122 and 142. The communication may include a command to adjust a switch and/or activate or modify a portion of circuitry to inject reactive power.

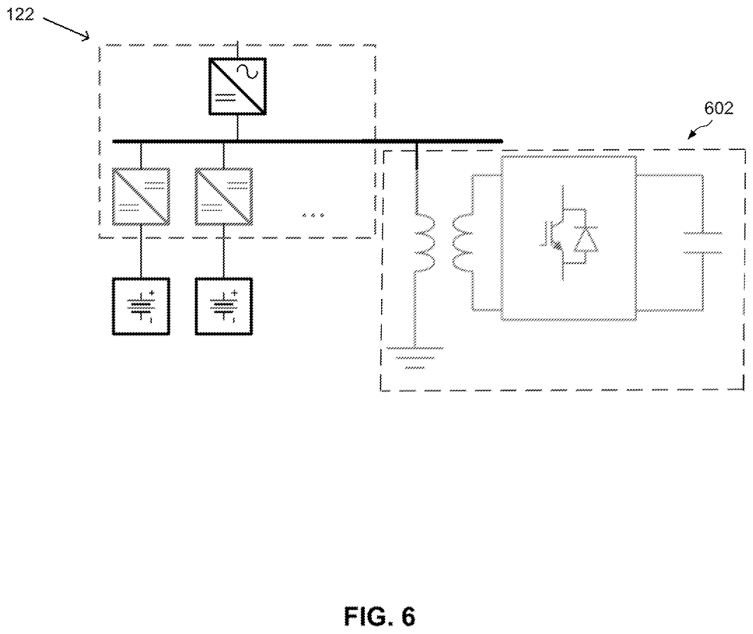

One example implementation of injecting reactive power is illustrated in FIG. 6. The compensating engine 502 may determine to activate or control a compensating circuit, or any other equivalent or similar mechanism, connected to or associated with one of the stations 102, 122 and 142. The communicating engine 501 may transmit a communication to any of the interfaces 188, 184 and 186 to activate or control a compensating circuit, or perform any other equivalent or similar mechanism. In some examples, the compensating engine 502 may activate a static synchronous compensator mode associated with one or the stations 102, 122 and 142, and/or associated with the compensating circuit. The compensating circuit may include a voltage source converter (VSC) connected with a reactance such as an inductor or transformer, which may switch a portion of the circuit to supply reactive power (e.g., capacitive reactive power) towards the connections 101, 121 and/or 141 upon detecting a voltage drop. However, if no voltage drop is detected then the compensating circuit may switch a different portion of the circuit so that no reactive power is supplied. The reactive power may, in turn, be transmitted towards the bus 120. Therefore, by supplying reactive power, the compensating engine 502 facilitates voltage stability, reliability, and efficiency of energy transport across the electric infrastructure 100.

The compensating engine 502 may, in some embodiments, be configured to address harmonic distortions. The compensating engine 502 may determine to initiate a harmonic filtering process, and/or actively inject harmonic currents in order to cancel out the harmonic distortions. The communicating engine 501 may transmit a communication to any of the interfaces 188, 184 and 186 to initiate such a harmonic filtering process and/or to actively inject harmonic currents.

Meanwhile, the energy injecting engine 504 and/or the energy redistributing engine 506 may be configured to address an outage, as detected by the outage detecting engine 404. First, the energy injecting engine 504 may determine to toggle off a circuit breaker to permit flow of electric energy. Next, the energy injecting engine 504 may determine to switch a mode of any of the stations 102, 122 and 142 from an energy acquiring mode, during which the stations 122 and/or 142 may be charging and acquiring energy from the one or more stations 102, 122 and/or 142 are injecting or distributing electric energy towards the connections 101, 121 and/or 141. The communicating engine 501 may transmit a communication to the interfaces 188, 184 and/or 186 to issue commands to the stations 102, 122 and/or 142 to perform these operations. The electric energy may, in turn, be transmitted towards the bus 120. This injection of electric energy may at least temporarily resolve the outage and reestablish operation of the electric infrastructure 100. In effect, the energy injecting engine 504 may switch a direction of energy flow at the stations 102, 122 and/or 142, which may in effect transform the stations 102, 122 and/or 142 into grid-forming inverters. In some examples, as the stations 122 and/or 142 distribute AC energy, the AC energy may be routed into the bus 120, following a boosting or conversion process to increase a voltage of the AC energy at the stations 102, 122 and/or 142.

In some embodiments, the energy injecting engine 504 may select one or more particular stations to supply energy, based on attributes such as stored energies, amounts of surplus energies, predicted amounts of surplus energies, predicted demands, and/or predicted surplus amounts of energy, within the one or more particular stations. The energy injecting engine 504 may determine these attributes, for example, based on historical data of the stations. For example, the energy injecting engine 504 may select one particular station that has a highest stored energy, combined across all energy sources, to supply energy, compared to other stations connected within the electric infrastructure 100. In other examples, the energy injecting engine 506 may select multiple particular stations that have among highest stored energies compared to other stations. In some examples, additionally or alternatively, the energy injecting engine 504 may select one or more particular stations to supply energy based on other criteria such as locations, frequency of utilization, demand, predicted or expected frequency of utilization or demand by entities, historical information such as ages of the stations, and/or efficiencies such as charging efficiencies of the stations. As one particular example, the energy injecting engine 504 may select a particular station that is closest or among the closest, compared to other stations, to an outage in order to reduce a distance that energy would be transmitted. As another particular example, the energy injecting engine 504 may select a particular station that is least frequently utilized or requested, or for which an amount of predicted energy consumed is lowest, in order to prevent depletion or energy deficiency of a frequently utilized or requested station. As another particular example, the energy injecting engine 504 may select a particular station that has a highest predicted surplus (e.g., difference between currently available energy and expected energy demand). As another particular example, the energy injecting engine 504 may select a particular station that is newest or among the newest, or most efficient compared to other stations because that particular station may be replenished or restored with energy more efficiently compared to other stations. Upon selection of the one or more particular stations by the energy injecting engine 504, the communicating engine 501 may transmit a communication, to one or more corresponding interfaces (e.g., the interface 188, 184 and/or 186), that the one or more particular stations are to supply energy. Following the communication, the corresponding interfaces 188, 184 and/or 186 may initiate a process to switch a mode of the one or more particular stations to supply energy.

The energy redistributing engine 506 may, in an event of an outage, redistribute electric energy among energy sources within a particular station. For example, the energy redistributing engine 506 may obtain a request to charge at a particular station, such as at the port 130 of the station 122. The request to charge may also indicate an urgency and/or a priority level, which may be correlated with a particular type of entity or a particular entity that is requesting to charge. For instance, an authority vehicle such as an emergency response vehicle may be correlated to a higher priority level compared to other non-authority vehicles. Thus, if the priority level is above a threshold priority level (e.g., such as that corresponding to authority vehicles), then the energy redistributing engine 506 may determine whether the amount of energy stored within the energy source 126 connected to the port 130 is sufficient to fulfill the request to charge. If the amount of energy is insufficient, which indicates a potential deficiency, then the energy redistributing engine 506 may redistribute energy, or direct the redistribution of energy, from any other remaining energy sources within the station 122 besides the energy source 126 to supply sufficient energy to the energy source 126.

The redistribution of energy may include directing the transmission of electric energy from the other remaining energy sources in proportion to individual remaining energy levels within the other energy sources. For example, if the energy source 128 has 10 kilowatt hours (kWh) available while a third energy source (not shown in FIG. 1) within the station 122 has 15 kWh available, then 40 percent of the total energy redistributed to the energy source 126 would be transmitted from the energy source 128 while 60 percent of the total energy redistributed would be transmitted from the third energy source. In other examples, the redistribution of energy from the other remaining energy sources may be in proportion to estimated surplus energy levels (e.g., a difference between available energy and expected demand for energy) within the other energy sources. The communicating engine 501 may transmit a communication to the interface 184 to redistribute energy by transferring energy out of the remaining energy sources to the energy source 126. Following the transmission of the communication, the interface 184 may activate a redistribution process, which may encompass adjusting one or more circuit components within the station 122. For example, the interface 184 may initiate a process to close a switch or otherwise modify circuitry or functionality within the station 122 to permit the energy source 126 to receive energy.

In some embodiments, the energy redistributing engine 506 may also redistribute energy from one or more other stations (e.g., the station 142) in order to remedy a potential or actual deficiency within the station 122, if transmission of energy from the station 142 to the station 122 has been restored and/or is possible. In some embodiments, when multiple candidate stations may redistribute energy to the station 122, the energy redistributing engine 506 may select one or more particular stations from the candidate stations, using an analogous criteria including any or all of the principles as described above regarding individual energy sources. For example, the energy redistributing engine 506 may make the selection based on estimated surplus energy levels within the stations, available energy levels within the stations, and/or locations of the stations.

Upon the energy redistributing engine 506 selecting the one or more particular stations, the communicating engine 501 may transmit a communication to one or more corresponding interfaces to redistribute energy by transferring energy out of the one or more particular stations to the station 122. Additionally, the communicating engine 501 may transmit a communication to the interface 184, that the station 122 is scheduled to receive energy. Following the transmission of the communication, the one or more corresponding interfaces may initiate a redistribution process, for example, by adjusting respective circuit components within the one or more particular stations to transfer energy out. Additionally, the interface 184 may initiate a process to adjust circuit components of the station 122 (e.g., closing the switch) to prepare to receive an energy transmission. In such a manner, the energy redistributing engine 506 may ensure that the energy will reach the intended station.

FIG. 6 is a diagram illustrating an example operation of reactive energy compensation upon a transmission quality decrease being detected, such as a voltage decrease, within the electric infrastructure 100, as related to the compensating engine 502. In some examples, the compensating engine 502 may activate and/or control operations of a compensating circuit 602, or some equivalent or analogous mechanism to supply reactive energy. The compensating circuit 602 may be associated with or connected to any of the stations (e.g., the station 122). The compensating circuit 602 may include a VSC connected with a reactance such as an inductor or transformer, which may supply reactive power (e.g., capacitive reactive power) towards the connections 101, 121 and/or 141. The reactive power may, in turn, be transmitted towards the bus 120.

FIG. 7 is a block diagram illustrating details of the imbalance detecting engine 306, which includes hardware, software and/or firmware capable of secure and efficient communication with the stations 102, 122 and/or 142, and/or any of the entities 110, 112, 130, 132, 150, and/or 152. The imbalance detecting engine 306 may include a communicating engine 701, an intrastation imbalance detecting engine 702 and an interstation imbalance detecting engine 704. The communicating engine 701 may receive communications via any of the interfaces 188, 184, and 186 and transmit the communications to any of the intrastation imbalance detecting engine 702 and the interstation imbalance detecting engine 704. In particular, the communicating engine 701 may receive readings and/or communications from one or more sensors or components. These sensors may measure parameters indicative of imbalance, such as amounts of energy stored within the individual energy sources (e.g., the energy sources 126, 128, 146, and 148) as well as amounts of energy stored within the stations (e.g., the stations 122 and 142), indicators of transmission and/or energy quality (e.g., level of consistency or stability in voltage and/or frequency, and/or signal waveform properties). The communicating engine 701 may receive other records or logs of events occurring within the electric infrastructure 100. In some embodiments, the communicating engine 701 may transmit a request for information to any of the interfaces 188, 184, and 186. In some embodiments, additionally or alternatively, the communicating engine 401 may automatically receive communications of events and/or data from the interfaces 188, 184, and 186 in real-time, near real-time, or at certain intervals. The communicating engine 701 may transmit any communications received to the intrastation imbalance detecting engine 702 and to the interstation imbalance detecting engine 704.

The intrastation imbalance detecting engine 702 may be configured to detect an imbalance among parameters within a particular station, following receipt of any transmitted communications by the communicating engine 701. For example, the intrastation imbalance detecting engine 702 may detect an uneven distribution of stored energy among individual energy sources within a station (e.g., the energy sources 126 and 128 within the station 122). The intrastation imbalance detecting engine 702 may determine an uneven distribution if, for example, one or more individual energy sources deviates from some index, such as an average amount of stored energy across the energy sources within a station. One particular scenario may be that, for the station 122, that the energy source 126 has an available stored energy of 1 kWh while the energy source 128 has an available stored energy of 15 kWh, which is fifteen times that of the energy source 126. In this scenario, the intrastation imbalance detecting engine 702 may detect an uneven distribution of stored energy. The intrastation imbalance detecting engine 702 may also detect an uneven distribution and/or other imbalances of other parameters within a particular station, such as indicators of energy quality (e.g., level of consistency or stability in voltage and/or frequency, and/or signal waveform properties).

The interstation imbalance detecting engine 704 may be configured to detect an imbalance pertaining to parameters across different stations following receipt of any transmitted communications by the communicating engine 701. For example, the interstation imbalance detecting engine 704 may detect an uneven distribution of stored energy among different stations, and/or a deviation in one or more particular stations between a current parameter (e.g., current stored energy) and a benchmark (e.g., an expected or recommended amount of total energy stored at a station). In some embodiments, as alluded to previously in FIG. 3, benchmark values for different stations may differ from one another and may be based on a relative and/or an absolute geospatial location, historical demand, and/or predicted demand. For example, if historically, more energy is drawn from one station (e.g., the station 122) compared to a different station (e.g., the station 142), then a benchmark amount of total energy at that one station may be higher compared to the benchmark amount of total energy at the different station due to higher expected demands at the station 122. Additionally or alternatively, if historically, one station is associated with a higher rate of faults compared to a different station, then more energy may be expected to be drawn from that one station compared to the different station. Thus, a benchmark amount of total energy at that one station may be higher compared to the benchmark amount of total energy at the different station. Additionally or alternatively, if historically, one station is associated with a higher priority of energy requests (e.g., entities of a particular type are more likely to request at that one station) compared to a different station, then a benchmark amount of total energy at that one station may be higher compared to the benchmark amount of total energy at the different station. In other examples, additionally or alternatively, the interstation imbalance detecting engine 704 may detect an imbalance if a current demand or request for energy from an entity exceeds an available amount of energy. The interstation imbalance detecting engine 704 may also detect an uneven distribution and/or other imbalances of other parameters across different stations, such as indicators of energy quality (e.g., level of consistency or stability in voltage and/or frequency, and/or signal waveform properties).

FIG. 8 is a block diagram illustrating details of the imbalance addressing engine 308, which includes hardware, software and/or firmware capable of secure and efficient communication with the stations 102, 122 and/or 142, and/or any of the entities 110, 112, 130, 132, 150, and/or 152. The imbalance addressing engine 308 may include a communicating engine 801, an intrastation imbalance addressing engine 802 and an interstation imbalance addressing engine 804. The communicating engine 801 may be configured to translate and/or communicate any commands received by the intrastation imbalance addressing engine 802 and the interstation imbalance addressing engine 804 to any of the interfaces (e.g., the interfaces 188, 184 and 186, 189, and/or 185). The intrastation imbalance addressing engine 802 may be configured to selectively resolve any imbalances detected by the intrastation imbalance detecting engine 702, such as restoring or reestablishing a balance among parameters within a particular station. For example, the intrastation imbalance addressing engine 802 may control a transmission or diverting of stored energy from one energy source (e.g., the energy source 128) to another energy source (e.g., the energy source 126), upon the intrastation imbalance detecting engine 702 detecting an uneven distribution of energy among different energy sources. The communicating engine 801 may transmit a communication, to the interface 184, in order for the station 122 to redistribute energy from the energy source 128 into the energy source 126. In turn, the interface 184 may initiate a process to adjust circuitry or other functionality within the station 122 in order to commence the transmission of energy from the energy source and to permit the energy source 126 to receive the energy.

The interstation imbalance addressing engine 804 may be configured to selectively resolve any imbalances detected by the interstation imbalance detecting engine 704, such as controlling a redistribution of stored energy among different stations in order to satisfy the benchmarks for all stations, or for as many stations as possible. In some embodiments, the redistribution of stored energy may depend on the aforementioned criteria such as historical frequency of access or utilization of stations, rates of faults occurring at or near, or associated with the stations, and/or priorities or urgencies of requests for energy at the stations. Thus, the interstation imbalance addressing engine 804 may distribute electric energy among stations depending on differences in expected energy consumption, expected or actual energy demands among the different stations, and/or depending on current demands for energy. For example, the interstation imbalance addressing engine 804 may divert or redistribute energy from a station having an expected surplus of energy to another station that has an expected deficiency of energy, based on a different of current energy amounts and predicted demands for energy. The communicating engine 801 may transmit a communication, to any of the interfaces (e.g., the interface 188, 184, 186, 189, and/or 185) to redistribute or receive energy. In turn, the interface 188, 184 and/or 186 may initiate a process to adjust circuitry or functionality within the stations 102, 122, and/or 142 in order to commence the transmission of energy or to receive energy, to ensure that energy is properly routed from a source to a destination rather than being mistakenly delivered to unintended destinations.

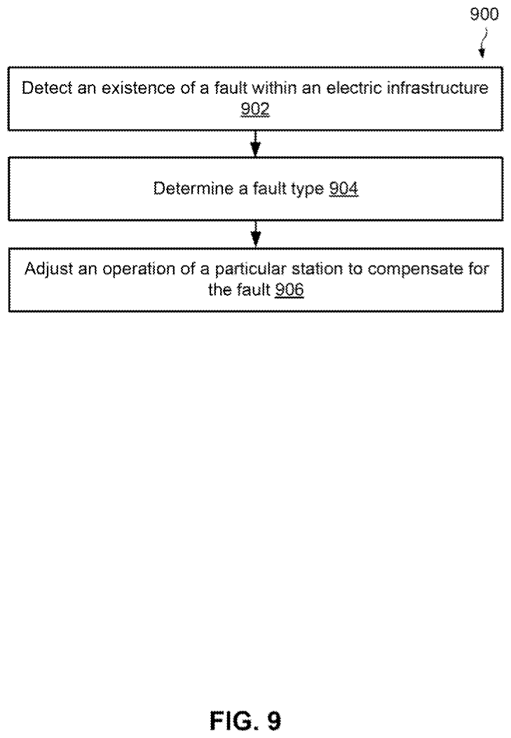

FIG. 9 is a flowchart of a method 900 of controlling a response to a detected fault within an electric infrastructure (e.g., the electric infrastructure 100 of FIG. 1). In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

Method 900 begins with step 902, in which one or more processors (e.g., the controller 160, in particular, the fault detecting engine 302) detect an existence of a fault within the electric infrastructure. For example, as explained previously, a fault may include an outage or a loss in performance, such as a voltage drop and/or harmonic distortion. In step 904, one or more hardware processors (e.g., the fault detecting engine 302) may, in response to detecting an existence of a fault, determine a type of the fault. In step 906, one or more hardware processors (e.g., the fault addressing engine 304) may, in response to the detecting of the fault, adjust an operation or a mode of a particular station, or one or more stations (e.g., the stations 102, 122 and/or 142) to compensate for the fault, based on a type of the fault detected. The adjusting of the operation or the mode may encompass coordinating a transmission of electric signals or electric energy from the station towards the bus 120 (e.g., in an opposite direction from which electric energy was received from the power supply 155 or alternatively from one or more different regional infrastructures 195 to the one or more stations) in order to compensate for the fault. For example, the coordinating of the transmission of electric signals may include injecting reactive power in response to a transmission quality loss being detected. Such a transmission quality loss may be evidenced by a voltage drop. As another example, the coordinating of the transmission of electric signals may include transmitting harmonic currents to counteract harmonic distortion. As another example, the coordinating of the transmission of electric signals may include transmitting AC energy from one or more stations in response to an outage.

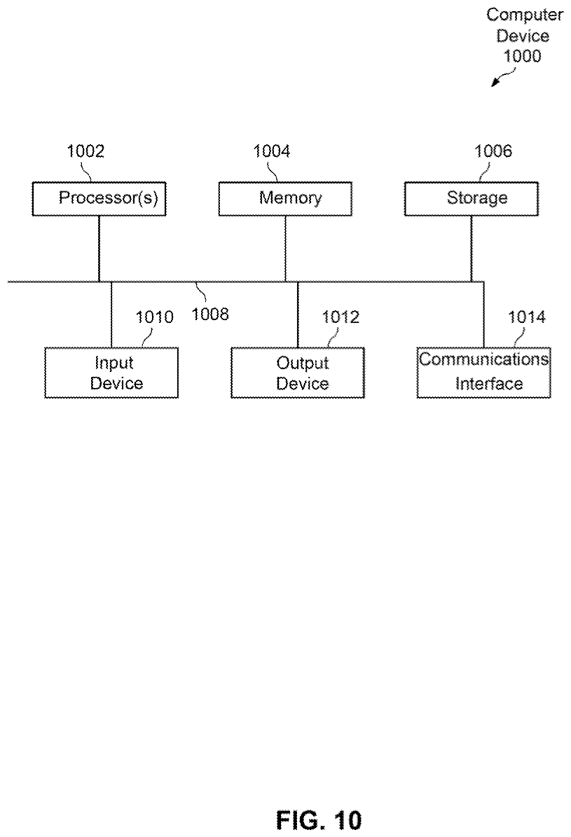

FIG. 10 is a block diagram of a computing device 1000. Any of the controller 160 and/or engines described herein may comprise an instance of one or more computing devices 1000. In some embodiments, functionality of the computing device 1000 is improved to perform some or all of the functionality described herein. The computing device 1000 comprises a processor 1002, memory 1004, storage 1006, an input device 1010, a communication network interface 1014, and an output device 1012 communicatively coupled to a communication channel 1008. The processor 1002 is configured to execute executable instructions (e.g., programs), and may be implemented as the controller 160. In some embodiments, the processor 1002 comprises circuitry or any processor capable of processing the executable instructions.

The memory 1004 stores data. Some examples of memory 1004 include storage devices, such as RAM, ROM, RAM cache, virtual memory, etc. In various embodiments, working data is stored within the memory 1004. The data within the memory 1004 may be cleared or ultimately transferred to the storage 1006.

The storage 1006 includes any storage configured to retrieve and store data. Some examples of the storage 1006 include flash drives, hard drives, optical drives, cloud storage, and/or magnetic tape. In some embodiments, storage 1006 may include RAM. Each of the memory 1004 and the storage 1006 comprises a computer-readable medium, which stores instructions or programs executable by processor 1002.

The input device 1010 may be any device that inputs data (e.g., mouse and keyboard). The output device 1012 may be any device that outputs data and/or processed data (e.g., a speaker or display). It will be appreciated that the storage 1006, input device 1010, and output device 1012 may be optional. For example, the routers/switchers may comprise the processor 1002 and memory 1004 as well as a device to receive and output data (e.g., the communication network interface 1014 and/or the output device 1012).

The communication network interface 1014 may be coupled to a network (e.g., the network 162) via the link 1008. The communication network interface 1014 may support communication over an Ethernet connection, a serial connection, a parallel connection, and/or an ATA connection. The communication network interface 1014 may also support wireless communication (e.g., 802.11 a/b/g/n, WiMax, LTE, WiFi). It will be apparent that the communication network interface 1014 may support many wired and wireless standards.

It will be appreciated that the hardware elements of the computing device 1000 are not limited to those depicted. A computing device 1000 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1002 and/or a co-processor located on a GPU (i.e., NVidia).

It will be appreciated that an “engine,” “system,” “datastore,” and/or “controller” may comprise software, hardware, firmware, and/or circuitry. In one example, one or more software programs comprising instructions capable of being executable by a processor may perform one or more of the functions of the engines, systems, datastores, and/or controller described herein. In another example, circuitry may perform the same or similar functions. Alternative embodiments may comprise more, less, or functionally equivalent engines, systems, datastores, or databases, and still be within the scope of present embodiments. For example, the functionality of the various engines, systems, datastores, and/or controller may be combined or divided differently. The datastores may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or controller described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. References to “approximately” may be construed to encompass values within a certain range of the specified value, such as within 25 percent, 10 percent, 5 percent, 1 percent, or any other applicable value. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A system for controlling an electric infrastructure, comprising:
one or more interfaces coupled to one or more stations, each station comprising one or more solid state transformers (SSTs), the one or more stations being operable to receive first electric energy via a bus from a power supply, each station operable to transmit second electric energy to one or more entities, each station further operable to transmit third electric energy back towards the bus; and
a controller system comprising the one or more interfaces and a controller, the controller system further comprising:
one or more hardware processors; and
memory storing computer instructions, the computer instructions when executed by the one or more hardware processors configured to perform:
detecting an existence of a fault within the electric infrastructure, the fault indicating an outage or loss in performance in at least a portion of the electric infrastructure;
in response to detecting an existence of a fault, determining a fault type; and
based on the fault type, adjusting an operation of a particular station of the stations to compensate for the fault, the adjusting the operation including coordinating a transmission of the third electric energy towards the bus to compensate for the fault.

2. The system of claim 1,
wherein the determining of the fault type comprises detecting that the fault type includes a voltage drop; and
wherein the coordinating of the transmission of the third electric energy includes coordinating the particular station to inject a portion of reactive power towards the bus to compensate for the voltage drop.

3. The system of claim 1,
wherein the determining of the fault type includes detecting that the fault type includes an outage; and
wherein the coordinating of the transmission of the third electric energy includes selecting the particular station to transmit the third electric energy towards the bus based on stored electric energy within the particular station.

4. The system of claim 3, wherein the selecting of the particular station includes determining the particular station has a surplus of stored energy based on an expected energy demand corresponding to the particular station.

5. The system of claim 3, wherein the computer instructions when executed by the one or more hardware processors are further configured to perform:
switching a mode of the particular station from an energy acquiring mode to an energy supplying mode, wherein the energy supplying mode transforms or converts the one or more particular stations into one or more grid-forming inverters.

6. The system of claim 1, wherein the computer instructions when executed by the one or more hardware processors are further configured to perform:
receiving a request from a particular entity for urgent electric energy from a first station, wherein the first station comprises the particular station or a different station;
determining a level of urgency or a level of priority of the request;
determining that stored energy at the first station is insufficient to fulfill the request; and
selectively redistributing external electric energy from one or more other stations besides the first station to meet the request.

7. The system of claim 6, wherein the determining the level of urgency or the level of priority is based on a type of the particular entity.

8. The system of claim 6, wherein the selectively redistributing the external electric energy from the one or more other stations to the first station comprises redistributing the external electric energy in proportion to available energy levels at the respective other stations.

9. The system of claim 1, wherein
the determining of the fault type includes determining that the fault type includes a harmonic distortion within a waveform of the electric energy; and
the coordinating of the transmission of the third electric energy comprises coordinating the particular station to transmit harmonic signals to counteract the harmonic distortion.

10. The system of claim 1, wherein the computer instructions when executed by the one or more hardware processors are further configured to perform:
detecting an imbalance within the electric infrastructure, the imbalance including an uneven distribution of available electric energy across different stations; and
in response to detecting the imbalance, selectively redistributing the available electric energy among at least a subset of the different stations.

11. A method implemented by a controller system within an electric infrastructure, wherein the controller system comprises a controller and one or more interfaces coupled to and communicating with one or more stations each comprising one or more solid state transformers (SSTs), the method comprising:
receiving, at the one or more stations, first electric energy via a bus from a power supply;
transmitting, at the one or more stations, second electric energy to one or more entities;
detecting an existence of a fault within the electric infrastructure, wherein the fault indicates an outage or a loss in performance in at least a portion of the electric infrastructure;
in response to detecting an existence of a fault, determining a type of the fault; and
based on the type of the fault, adjusting an operation of a particular station of the one or more stations to compensate for the fault, wherein the adjusting of the operation comprises coordinating a transmission of third electric energy from the particular station towards the bus of the electric infrastructure in order to compensate for the fault.

12. The method of claim 11, wherein the determining of the type of the fault comprises:
detecting that the fault type includes a voltage drop; and
wherein the coordinating of the transmission of the third electric energy includes coordinating the particular station to inject a portion of reactive power towards the bus to compensate for the voltage drop.

13. The method of claim 11, wherein the determining of the fault type includes detecting that the fault type includes an outage; and
wherein the coordinating of the transmission of the third electric energy includes selecting the particular station to transmit the third electric energy towards the bus based on stored electric energy within the particular station.

14. The method of claim 13, wherein the selecting of the particular station includes determining the particular station has a surplus of stored energy based on an expected energy demand corresponding to the particular station.

15. The method of claim 13, further comprising:
switching a mode of the particular station from an energy acquiring mode to an energy supplying mode, wherein the energy supplying mode transforms or converts the one or more particular stations into one or more grid-forming inverters.

16. The method of claim 11, further comprising:
receiving a request from a particular entity for urgent electric energy from a first station, wherein the first station comprises the particular station or a different station;
determining a level of urgency or a level of priority of the request;
determining that stored energy at the first station is insufficient to fulfill the request; and
selectively redistributing external electric energy from one or more other stations besides the first station to meet the request.

17. The method of claim 16, wherein the determining the level of urgency or the level of priority is based on a type of the particular entity.

18. The method of claim 16, wherein the selectively redistributing the external electric energy from the one or more other stations to the first station comprises redistributing the external electric energy in proportion to available energy levels at the respective other stations.

19. The method of claim 11, wherein the determining of the fault type includes determining that the fault type includes a harmonic distortion within a waveform of the electric energy; and
the coordinating of the transmission of the third electric energy comprises coordinating the particular station to transmit harmonic signals to counteract the harmonic distortion.

20. The method of claim 11, further comprising:
detecting an imbalance within the electric infrastructure, the imbalance including an uneven distribution of available electric energy across different stations; and
in response to detecting the imbalance, selectively redistributing the available electric energy among at least a subset of the different stations.
